(19) United States
(12) Patent Application Publication
(10) Pub. No.: US 2005/0021770 A1
(43) Pub. Date: Jan. 27, 2005

(54) Method for transferring PPP inactivity time in a CDMA2000 network

(76) Inventors: Guy Helm, Plano, TX (US); Kuntal Chowdhury, Plano, TX (US); Peter W. Wenzel, Plano, TX (US)

Correspondence Address: James A. Harrison, P.O. Box 670007, Dallas, TX, 75367, US

(21) Appl. No.: 10/745,328

(22) Filed: Dec. 23, 2003

Related U.S. Application Data
(60) Provisional application No. 60/478,229, filed on Jun. 13, 2003.

(51) Int. Cl. G06F 15/16

(52) U.S. Cl. 709/228; 709/230

(57) ABSTRACT

A packet data service node is formed to establish an “always on” connection with a mobile terminal by way of a packet control function card or device with the ability to determine when a mobile terminal no longer requires a previously established point-to-point protocol communication link. Thus, to prevent unnecessary communications after a mobile terminal loses RF, the PDSN transmits a PPP inactivity timer remaining timer to the mobile terminal. The mobile terminal then generates communication s signals to the PDSN after regaining RF based upon an internal counter value initialized with the received PPP inactivity time remaining counter. In the described embodiment, the timer remaining timer value is equal to the inactivity timer summed with a total amount of time expected to be expended (in a worst case situation) soliciting responses from the mobile terminal with pings (e.g., LCP-Echo-Requests).

### CROSS REFERENCE TO RELATED APPLICATION

This application is related to, incorporates by reference and claims priority to Provisional Application for Patent having a title of METHOD FOR TRANSFERRING PPP INACTIVITY TIME IN A WIRELESS NETWORK and having a Ser. No. of 60/478,229 and a filing date of Jun. 13, 2003.

### BACKGROUND

1. Field of the Invention

The present invention relates to mobile communication devices and, more particularly, the present invention relates to mobile terminals capable of communicating in a data-only mode with a data network, as well as mobile terminals capable of communicating in voice and data modes.

2. Related Art

Wireless communication service providers, as well as Internet service providers, face some difficult challenges as the various networks are increasingly modified to work together to provide seamless end-to-end call connectivity across the various platforms. Ever-increasing residential dial-up subscribers demand available modem (or ISDN) ports, or threaten to take their business elsewhere. To meet this demand, Internet service providers are deploying a large number of complex, port-dense Network Access Servers (NAS) to handle thousands of individual dial-up connections. As such, small and large, as well as private and public, wireless data networks are being created to seamlessly interact with large wire line networks to enable users to establish point-to-point connections independent of terminal type and location. Traditionally, however, voice networks have paved the way for the creation of data networks as users loaded the voice networks trying to transmit data, including streaming data (video and voice). Initially, traditional Public Switched Telephone Networks (PSTNs) were used for data transmissions but have been largely supplanted by data packet networks, including various versions of the “Internet”.

The wireless domain has had a parallel history. Initial voice networks, including Advanced Mobile Phone Service (AMPS), Time Division Multiple Access (TDMA) including North American TDMA and Global System for Mobile Communications (GSM), were used to conduct data in a limited capacity. These networks are being replaced, however, by newer wireless data-only networks, as well as data and voice networks.

The structure and operation of wireless communication systems are generally known. Examples of such wireless communication systems include cellular systems and wireless local area networks, among others. Equipment that is deployed in these communication systems is typically built to support standardized operations, i.e., operating standards. These operating standards prescribe particular carrier frequencies, modulation types, baud rates, physical layer frame structures, MAC layer operations, link layer operations, etc. By complying with these operating standards, equipment interoperability is achieved.

In a cellular system, a regulatory body typically licenses a frequency spectrum for a corresponding geographic area (service area) that is used by a licensed system operator to provide wireless service within the service area. Based upon the licensed spectrum and the operating standards employed for the service area, the system operator deploys a plurality of carrier frequencies (channels) within the frequency spectrum that support the subscriber units within the service area. Typically, these channels are equally spaced across the licensed spectrum. The separation between adjacent carriers is defined by the operating standards and is selected to maximize the capacity supported within the licensed spectrum without excessive interference. In most cases, severe limitations are placed upon the amount of co-channel and adjacent channel interference that maybe caused by transmissions on a particular channel.

In cellular systems, a plurality of base stations is distributed across the service area. Each base station services wireless communications within a respective cell. Each cell may be further subdivided into a plurality of sectors. In many cellular systems, e.g., GSM cellular systems, each base station supports forward link communications (from the base station to subscriber units) on a first set of carrier frequencies, and reverse link communications (from subscriber units to the base station) on a second set of carrier frequencies. The first set and second set of carrier frequencies supported by the base station are a subset of all of the carriers within the licensed frequency spectrum. In most, if not all, cellular systems, carrier frequencies are reused so that interference between base stations using the same carrier frequencies is minimized and system capacity is increased. Typically, base stations using the same carrier frequencies are geographically separated so that minimal interference results.

Traditional wireless mobile networks include Mobile Station Controllers (MSCs), Base Station Controllers (BSCs) and Base Transceiver Station (BTS) systems that jointly operate to communicate with mobile stations over a wireless communication link. Examples of common networks include the GSM networks, North American TDMA networks and Code Division Multiple Access (CDMA) networks. Extensive infrastructures (e.g., ANSI-41 or MAP-based networks) exist in the cellular wireless networks for tracking mobility, distributing subscriber profiles, and authenticating physical devices.

To establish a wireless communication link in traditional wireless voice networks, an MSC communicates with a BSC to prompt the BTS (collectively “Base Station” or “BS”) to generate paging signals to a specified mobile station within a defined service area typically known as a cell or sector (a cell portion). The mobile station, upon receiving the page request, responds to indicate that it is present and available to accept an incoming call. Thereafter, the BS, upon receiving a page response from the mobile station, communicates with the MSC to advise it of the same. The call is then routed through the BS to the mobile station as the call setup is completed and the communication link is created. Alternatively, to establish a call, a mobile station generates call setup signals that are processed by various network elements in a synchronized manner to authenticate the user as a part of placing the call. The authentication process includes, for example, communicating with a Home Location Register (HLR) to obtain user and terminal profile information.

The next generation of cellular networks presently being developed are being modified from traditional systems to create the ability for mobile stations to receive and transmit data in a manner that provides greatly increased throughput rates. For example, many new mobile stations, often referred to as mobile terminals or access terminals, are being developed to enable a user to surf the web or send and receive e-mail messages through the wireless mobile terminal, as well as to be able to receive continuous bit rate data, including so called “streaming data”. Accordingly, different systems and networks are being developed to expand such capabilities and to improve their operational characteristics.

One example of a system that is presently being deployed with voice and data capabilities is the cdma2000 network. The cdma2000 network, however, is developed from the IS-95 networks that were optimized for voice transmissions and therefore is not optimized for transmitting data even though its data transport capability is significantly improved from prior art networks and systems. More formally, the 1xRTT standard defines CDMA operation for data transmissions.

One data-only network that is being developed is defined by the 1xEVDO standard. The 1xEVDO standard defines a time burst system utilizing a 1.25 MHz carrier that is set at a carrier frequency that is adjacent to the frequencies used by the voice networks. In one particular network, a 1.67 millisecond (mS) burst is used for the forward link in a 1xEVDO network. Typical 1xEVDO networks include a Packet Data Service Node (PDSN) for performing routing and switching for a data packet or data packet stream, an Access Network Controller (ANC) that establishes and manages the wireless communication link with the mobile terminal, and a Packet Control Function (PCF) that is largely an interface device for converting signals between the packet domain and a wireless network that will be used for the communication link.

The 1xEVDO network is optimized for forward link data applications. The next generation of 1xRTT networks that are being deployed can communicate with voice and data networks but do not process data as efficiently as the networks formed according to the 1xEVDO standard. Newer networks are also being designed and have evolved from the 1xEVDO standard, including 1xEVDV, which is for transmitting data as well as voice.

The 1xEVDO networks that have been previously described are not formed, however, to interact seamlessly between the voice and data networks. For example, the 1xEVDO networks do not have or fully utilize Signaling System Number 7 (SS7) type network components to assist with call setup, user and mobile station authentication, call routing, and feature delivery. The 1xEVDO networks are formed to carry data only and do not include the full functionality and capabilities of wireless voice networks. The infrastructure of the 1xEVDO network is different and simpler than SS7-based voice networks (wire line or wireless).

The 1xEVDO network does not provide all hand-off capabilities and functionality of traditional voice networks. Accordingly, present mobile terminals only provide some of these traditional voice network features and, in some cases, only in a rudimentary way. For example, the designs in the 1xEVDO standard only provide for user authentication, not terminal authentication. Because traditional SS7-type network components are not fully available in 1xEVDO networks, compatibility and control problems are readily noticeable.

One problem that has been identified in some Point-to-Point Protocol (PPP) networks, including 1xEVDO and 1xRTT networks, is that a connected mobile terminal in a dormant state may lose radio frequency (RF), meaning control channel (e.g., pilot signal) communication signal failure in a manner that a serving network element from an original cell area does not receive a response to a page. Thus, the serving network element cannot determine if a PPP connection should be maintained because the mobile terminal lost RF and did not receive the page. One approach to solving this problem is to merely repeat the page several times.

To counteract this problem, mobile terminals are often formed to immediately establish communications with a base station or access point immediately after losing RF. If an inactivity timer has not expired, however, such communication wastes RF resources because they are unnecessary. What is needed, therefore, is an efficient way of reducing unnecessary communications from a dormant mobile terminal in an always-connected PPP network when RF is established after being lost.

### SUMMARY OF THE INVENTION

A Packet Data Service Node (PDSN) is formed to establish an “always on” connection with a mobile terminal by way of a Packet Control Function (PCF) card or stand alone device in a manner that improves network efficiency by reducing the transmission of unnecessary control signals. More specifically, the PDSN formed according to one embodiment of the present invention, includes a PPP inactivity timer and corresponding logic to prompt it to generate a Link Control Protocol (LCP) Echo Request to the mobile terminal after expiration of the PPP inactivity timer. Additionally, the PDSN determines and generates a PPP inactivity time remaining timer value that is transmitted to the mobile terminal. The mobile terminal receives the PPP inactivity time remaining timer value and, after losing and regaining RF, evaluates a value of the PPP inactivity time remaining timer value to determine whether to generate a signal to indicate its presence. Generally, the mobile terminal receives and uses the PPP inactivity time remaining timer value to initialize a countdown timer (internal timer in the described embodiment) so that it may approximately determine an actual value of the PPP inactivity timer within the PDSN.

In the described embodiment of the invention, the PPP inactivity timer is initially set to a value that is a plurality of hours long. The PPP inactivity timer is reset each time data or control signals are received from the mobile terminal. Upon expiration of the PPP inactivity timer, the PDSN generates the LCP Echo Request (“ping”) if transmitted at layer 2 of a point-to-point protocol. In one embodiment of the invention, the LCP Echo Request is generated at least once and a total of three times prior to the release of network resources responsive to not receiving an LCP Echo Reply from the mobile terminal (which it should have generated had it received the LCP Echo Request generated by the PDSN). In an alternate embodiment, an Internet Control Message Protocol (ICMP) Echo Request may be transmitted at an IP protocol network layer 3 in place of the layer 2 PPP LCP Echo Request.

Accordingly, the logic defined by the mobile terminal for receiving the PPP inactivity time remaining timer value facilitates the mobile terminal being aware of whether it should make its presence known to the PDSN when in a dormant state and when RF has been lost. Accordingly, mobile terminals will no longer unnecessarily transmit communication signals, such as LCP Echo Requests or LCP Echo Replies, to a PDSN to assert their presence, though dormant, after losing RF. In the described embodiment of the invention, the PPP inactivity time remaining timer value is less than or equal to a sum of the PPP inactivity timer within the PDSN plus the value of an LCP Echo Reply-Timeout timer value that is multiplied with a sum of a specified number of LCP Echo Request retries plus 1. For example, if the specified number of LCP Echo Request retries is equal to 2, then the PPP inactivity time remaining timer value is less than or equal to the sum of the PPP inactivity timer plus the product of the LCP Echo Reply-Timeout timer value times 3. Thus, if a dormant mobile terminal loses RF and a value of its internal timer that represents the PPP inactivity time remaining timer value is greater than 0, then the mobile terminal may determine that a last LCP Echo Request has yet to be transmitted. Accordingly, the mobile terminal includes logic, in the described embodiment of the invention, to not produce any communication signals until either it transitions from a dormant state or it receives an LCP Echo Request.

In one embodiment of the invention, for “Always On” users, the PDSN supports 3GPP2 vendor specific Max PPP Inactivity Timer packet defining the PPP inactivity time remaining timer value as described herein is futher defined in the standards (RFC 2153) as a PPP Vendor specific packet and the configurable timer and counter referred to herein as the Echo-Reply-Timeout timer.

The format of the Max PPP Inactivity Timer packet is shown in Table 1 below:

TABLE 1
Max PPP Inactivity Timer Packet

| | | |
|---|---|---|
| Code | Identifier | Length |

Magic Number

| | |
|---|---|
| OUI | Kind |

Max PPP Inactivity Time

| | |
|---|---|
| wherein: | |
| Code = | 0 |
| Identifier = | The Identifier field shall be changed for |
| | each Vendor Specific packet sent |
| Length = | 16(octets) |
| Magic Number = | The Magic-Number field is four octets and |
| | aids in detecting links that are in the |
| | looped-back condition. Until the Magic- |
| | Number Configuration Option has been |
| | successfully negotiated, the Magic-Number |
| | shall be transmitted as zero. See the Magic- |
| | Number Configuration Option for further |
| | explanation. |
| OUI = | 0xCF0002 |
| Kind = | 1 |
| Max PPP Inactivity | 32-bit value = PPP inactivity time + |
| Timer = | Echo_Reply_Timeout timer × |
| | (Echo_Request_Retries + 1) |

Upon entering an IPCP Opened state on a PPP session configured for Always On Service, the PDSN starts the PPP inactivity timer for the PPP session, and sends the 3GPP2 (e.g., 1xRTT) vendor specific Max PPP Inactivity Timer packet over the main service instance. The PDSN resends the Max PPP Inactivity Timer packet a configurable number of times. The value in the Max PPP Inactivity Timer field is equal to PPP inactivity timer+Echo_Reply Timeout timer×(Echo_Request_Retries+1)] for the PPP session. The PDSN resets the PPP inactivity timer upon detection of traffic activity.

Upon expiration of the PPP inactivity timer, the PDSN sends an LCP Echo-Request message over the main service instance, and starts the Echo-Reply-Timeout timer for the PPP session. It also initializes the Echo-Request-Retries counter to a configurable integer value.

Upon receipt of an LCP Echo-Reply message, an LCP Code-Reject or any other PPP packet for the PPP session, the PDSN stops and resets the Echo-Reply-Timeout timer, resets the Echo-Request-Retries counter, and resets the PPP inactivity timer.

Upon expiration of the Echo-Reply-Timeout timer and when the Echo-Request-Retries counter value is greater than zero, the PDSN sends an LCP Echo-Request message, decrement the Echo-Request-Retries counter by one, and starts the Echo-Reply-Timeout timer. Upon expiration of the Echo-Reply-Timeout timer and when the Echo-Request-Retries counter value is equal to zero, the PDSN shall close the PPP session. In this case, the PDSN does not send an LCP Terminate-Request to the MS.

Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram of a communication network formed according to one embodiment of the present invention;

FIG. 2 is a functional block diagram that illustrates one embodiment of the present invention;

FIG. 3 is a signal sequence diagram that illustrates an embodiment of the present invention;

FIG. 4 is a flowchart that illustrates one method of the present invention;

FIG. 5 is a flowchart that illustrates a second aspect of one embodiment of the present invention;

FIG. 6 is a functional block diagram that illustrates one embodiment of a mobile terminal; and

FIG. 7 is a flowchart illustrating a method of a mobile terminal according to one embodiment of the present invention.

### DETAILED DESCRIPTION OF THE DRAWINGS

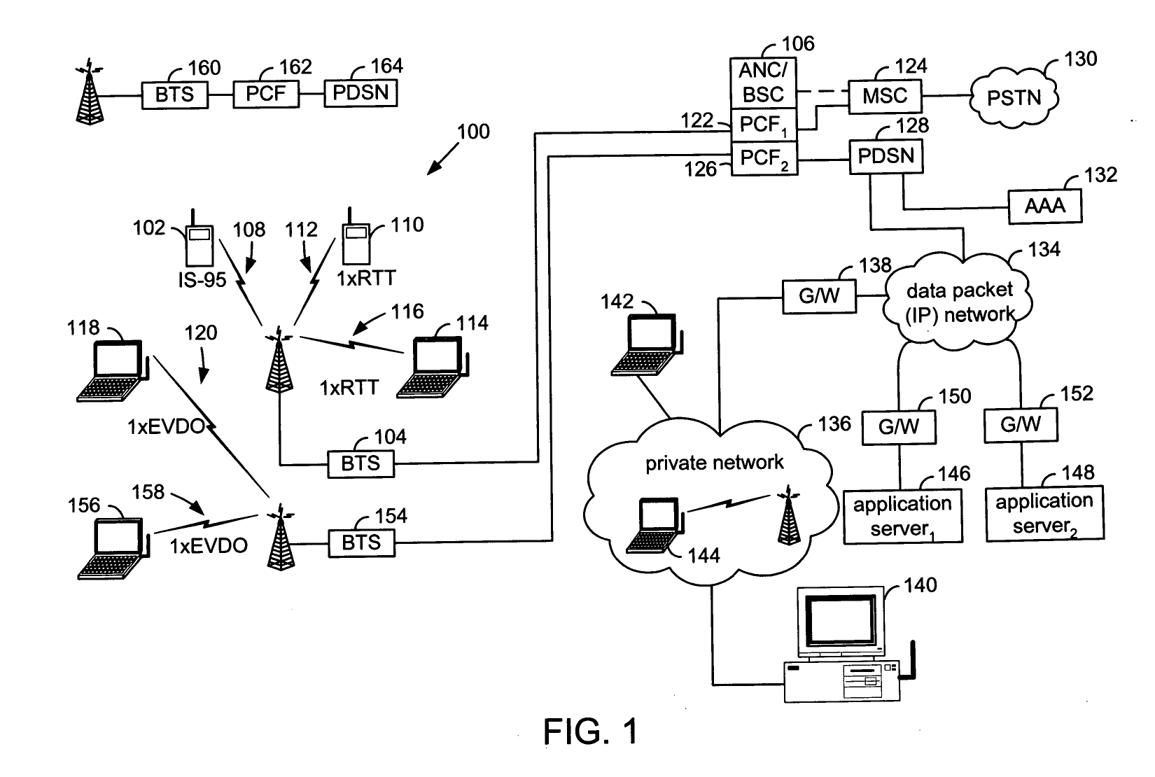

FIG. 1 is a functional block diagram of a communication network formed according to one embodiment of the present invention. As may be seen, a communication network 100 includes many networks that are coupled to operatively communicate with each other to enable a user in one type of network to communicate with a user in a different type of network. For example, communication network 100 creates an ability for a wire line user terminal coupled to a private network to communicate with a mobile terminal through a wireless communication link. Such transparent operation with respect to the user is improving access to information and the ability for individuals to communicate to a level that is unprecedented. As discussed before, existing wireless networks have, heretofore, been adapted primarily for carrying voice calls. Accordingly, when used in conjunction with a computer terminal, the wireless voice networks were able to transmit or receive data at rates that today are viewed as unacceptably slow although they were appreciated at the outset.

Along these lines, a mobile station 102 is located within a geographic area served by a Base Transceiver Station (BTS) 104 that is coupled to an Access Network Controller (ANC)/Base Station Controller (BSC) 106. More specifically, mobile station 102 communicates with BTS 104 by way of an IS-95 CDMA wireless communication network link shown generally at 108. Similarly, a mobile terminal 110 that is capable of supporting both voice and data calls communicates with BTS 104 over a wireless communication link shown generally at 112 and establishes either voice calls or data calls under the CDMA2000 1xRTT protocols. In the example herein, mobile terminal 110 is engaged in a voice call, as defined by a service option generated by a mobile terminal during call setup, and thus wireless communication link 112 is transmitting merely voice signals and associated control signaling.

Similarly, a mobile terminal 114 is engaged in a data call according to 1xRTT protocols over a wireless communication link shown generally at 116. Finally, a mobile terminal 118 is engaged in a data call over a wireless communication link, shown generally at 120, according to 1xEVDO protocols in a PPP network, as understood by one of average skill in the art. In general, some wireless PPP networks do not include control-signaling protocols that are as extensive as some existing systems.

The 1xEVDO network of the described embodiment is a high data rate, high performance and cost effective wireless data packet solution that offers high capacity and is optimized for packet data services. It provides a peak data rate, under current technology, of 2.4 Mbps within one CDMA carrier operating at a bandwidth of 1.2 MHz and supports Internet protocols and further facilitates an “always on” connection so that users are able to rapidly send and receive wireless data. Along these lines, the 1xEVDO network is formed to support connectionless communication links in contrast to traditional connection-oriented networks, such as the PSTN, and transmits Protocol Data Units (PDUs) which comprise data packets layered in a protocol such as an IP protocol. In general, the 1xEVDO transmits the PDUs in a bursty fashion notwithstanding its underlying CDMA technology. For hybrid mobile terminals capable of supporting both voice and data calls, the 1xEVDO transmits the PDUs for the data on separate 1.25 MHz channels with respect to voice thereby achieving higher system capacity.

1xEVDO network topology is a little different from traditional wireless networks, including 1xRTT data networks. More specifically, while wireless voice networks and 1xRTT data networks all include the use of a BSC and MSC for call control and call routing, a 1xEVDO system merely communicates through the radio with the ANC that, in turn, communicates with a packet data serving node which, in turn, is coupled to a data packet network such as the Internet.

Continuing to examine FIG. 1, BTS 104 is coupled to communicate with ANC/BSC 106. As is understood by one of average skill in the art, Access Network Controllers (ANCs) and Base Station Controllers (BSCs) have similar functionality. Moreover, Packet Control Function (PCF) cards can be installed either within a BSC or within an ANC according to whether the PCF is to communicate with a 1xRTT device or a 1xEVDO device, respectively. Additionally, in one embodiment of the invention, one ANC/BSC is formed with 1xRTT and 1xEVDO equipment therewithin to be multi-network capable. Thus, the embodiment of FIG. 1 contemplates such a configuration although it is to be understood that the BSC and ANC elements may readily be separated or formed as stand alone units.

Within ANC/BSC 106, according to one embodiment of the present invention, a plurality of different wireless network cards are included to facilitate communications with mobile stations and mobile terminals of differing protocols and types. For example, in the described embodiment, ANC/BSC 106 includes circuitry to communicate with mobile station 102 over IS-95 CDMA wireless communication network link as shown generally at 108. ANC/BSC 106 further includes a PCF 122 for communicating with mobile terminals 110 and 114 utilizing 1xRTT protocols in one described embodiment of the invention. PCF 122 is integrated into ANC/BNC 106 and is for communicating with 1xRTT protocol devices, and, to support such devices, is coupled to an MSC 124 for routing of data sessions of a voice network or hybrid voice and data network that utilizes mobile switching centers as are known by those of average skill in the art. A PCF 126, however, is for communicating with 1xEVDO devices and thus it is coupled directly to a Packet Data Serving Node (PDSN) 128. Thus, mobile terminal 118 that communicates over wireless communication link 120 according to 1xEVDO communication protocols, communicates with a BTS 154 and with PCF 126 formed within ANC/BSC 106 according to one embodiment of the present invention. It is understood, of course, that PCF 126 may readily be formed as a distinct device rather than within a rack of ANC/BSC 106. Moreover, PCF 126 may communicate with mobile terminal 118 through distinct radio equipment and, thus, through a BTS other than BTS 154 as shown herein.

MSC 124 further is coupled to a PSTN 130. Accordingly, calls routed through MSC 124 are directed either to other MSCs (not shown herein) or to external networks by way of PSTN 130. The reference to PSTN herein includes SS7 and other similar “intelligent networks”. Thus, a gateway device (not shown herein) coupled to PSTN 130, may be used to access a data packet network, such as the Internet, for any data calls transmitted according to 1xRTT protocols. 1xEVDO calls, which are processed by PCF 126, however, are forwarded through PDSN 128, which, upon authentication by an Authentication, Authorization and Accounting (AAA) server 132, is connected to a data packet network, such as a data packet network 134, which, in this example, comprises the Internet. As may further be seen, data packet network 134 is coupled to a private network 136 by way of a gateway device 138. Private network 136 further is coupled through traditional wire line networks to a user terminal 140 and 142. Moreover, in the described embodiment of the invention, private network 136 includes a wireless LAN formed according to 802.11b protocol standards that facilitates connection to a wireless terminal 144. Data packet network 134 further is coupled to a plurality of application servers, such as application servers 146 and 148 by way of gateway devices 150 and 152, respectively.

Any one of the 1xEVDO wireless mobile terminals 156 or 118 may also communicate through PCF 162 and PDSN 164 whenever they travel through a geographic region that is served by BTS 160 (assuming PCF 162 and PDSN 164 are 1xEVDO network compatible. In the described embodiment, PCF 162 is formed in a distinct device and is not formed as a card within a BSC as was the case with PCF 122 and PCF 126. As will be described in greater detail below, the present invention deals in part with the situation in which a data packet session has been established between a mobile terminal wherein the mobile terminal and its corresponding session become dormant and, thereafter, the mobile terminal loses RF.

In traditional “always on” PPP networks, a mobile terminal that loses RF (loses control channel communications with a base station, such as a pilot channel), automatically generates communication signals to establish its presence and to advise a base station or access point that it is present and able to establish a call or data session. In some cases, mobile terminals even seek to reestablish a new communication link after losing RF. Accordingly, if a base station or access point has not attempted to contact the mobile station because an inactivity timer has not expired, needless communication signals are transmitted, thereby creating interference to other users and, more generally, wasting system resources. The network and mobile terminal formed under the present invention, however, are both formed to combat such inefficiencies. More specifically, a base station, such as ANC/BSC 106, transmits, by way of a BTS, such as BTS 104 and BTS 154, a PPP inactivity time remaining timer value which is based on a PPP inactivity timer that is transmitted to the mobile terminals, for example, mobile terminals 118 and 156. Accordingly, mobile terminals 118 and 156, in this example, initiate an internal timer based upon the PPP inactivity time remaining timer value received from BTS 104 or BTS 154, respectively, to enable the mobile terminals 118 and 156 to determine whether to establish communications with the wireless network after losing RF. More specifically, each of the mobile terminals 118 and 156 will evaluate a value of the internal timer that monitors the PPP inactivity time remaining timer value and only generate communication signals after losing RF if the PPP inactivity time remaining timer value reflected in the internal counter is less than or equal to a specified value. For example, in one embodiment of the invention, the mobile terminals 118 and 156 only generate communication signals to reestablish a PPP data session if the PPP inactivity time remaining timer value is equal to 0 after the mobile terminal regains RF. In another embodiment of the invention, however, the mobile terminals 118 and 156 generate control channel communication signals whenever the PPP inactivity time remaining timer value is merely less than a specified value. For example, if the remaining amount of time, as reflected by the PPP inactivity time remaining timer value, is less than a specified value, then the mobile terminal may readily determine that at least one LCP-Echo Request has been produced by a base station. In this embodiment, the mobile terminal generates communication signals to advise the base station that the mobile terminal is present.

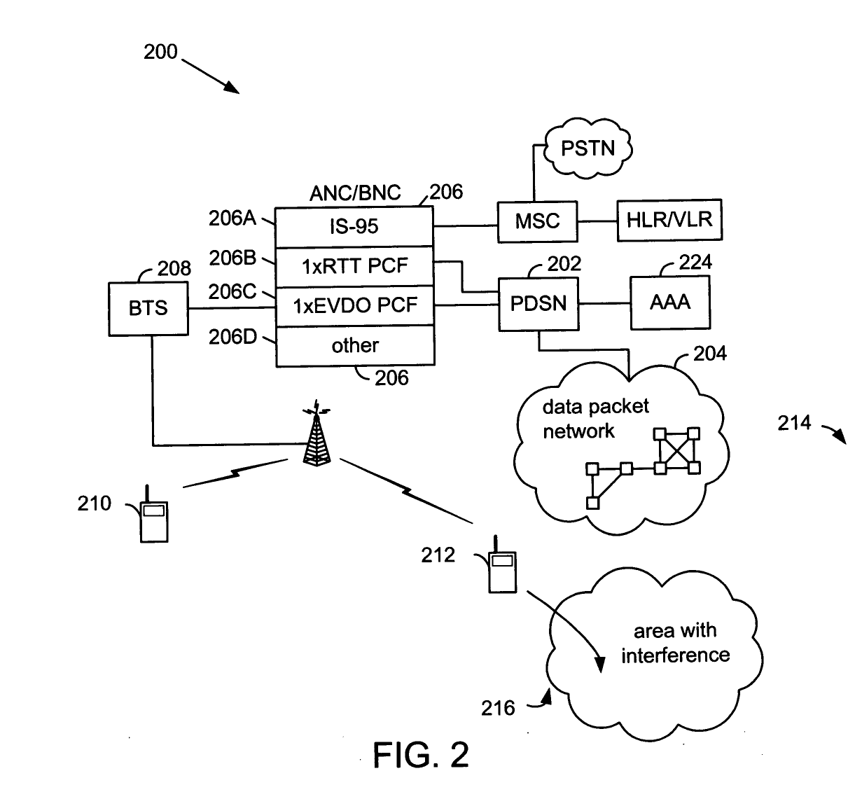

FIG. 2 is a functional block diagram that illustrates one embodiment of the present invention. As may be seen, a PDSN 202 is coupled to a data packet network 204, as well as to an ANC/BSC 206. As is known by one of average skill in the art, an access network control (ANC) provides functionality similar to that of base station controllers. In the described embodiment, ANC/BSC 206 includes an IS-95 card 206A, a 1xRTT PCF card 206B, a 1xEVDO PCF card 206C, in addition to other circuitry shown at 206D. Moreover, as systems evolve and, for example, 1xEVDO migrates to providing support for voice calls also, card 206C may well be replaced by a 1xEVDV PCF card which supports both voice and data calls.

ANC/BSC 206 further is coupled to a BTS 208 that communicates with a plurality of mobile terminals 210 and 212. Moreover, as may be seen, BTS 208 serves mobile terminals 210 and 212 that are within a defined geographic area represented by geographic marker 214. Geographic marker 214 may, for example, represent the boundaries of a wireless cell which, for a 1xEVDO system, may experience interference due to fading, multi-path interference and, more generally, low signal-to-noise ratio.

Continuing to refer to FIG. 2, it may be seen that mobile terminal 212 is headed in a direction to transition into an area 216 served by BTS 208 that is experiencing interference. For the present example, it is assumed that mobile terminal 212 is in a dormant state. Prior to transitioning into a dormant state, however, mobile terminal 212 must establish a communication link to have network resources allocated to it. Thus, as a part of initially establishing the call, mobile terminal 212 transmits communication control signals to BTS 208 to set up an “always on” call. BTS 208 communicates with 1xEVDO PCF 206C which, in turn, communicates with PDSN 202 to establish the call. PDSN 202 then generates a mobile station ID for mobile terminal 212 to a AAA server 224 to authenticate the mobile station ID prior to granting network resources thereto. Thus, once a point-to-point communication link is established between mobile terminal 212 and a device coupled to data packet network 204 by way of BTS 208, 1xEVDO PCF 206C and PDSN 202, mobile terminal 212 transitions into a dormant state (in the described embodiment) as it travels from the cell served by BTS 208 to area 216 which provides interference sufficient to prompt mobile terminal 212 to lose RF. PDSN 202, however, continues to reserve the resources for a mobile terminal 212 in an “always on” or “always connected” type network implementation. Accordingly, as will be explained in greater detail below, PDSN 202 will periodically generate “ping” requests to mobile terminal 212 to ensure that it is still within the cell area served by it through BTS 208. Should mobile terminal 212 fail to reply to a “ping” request and, in the described embodiment, after multiple “ping” requests, then PDSN 202 releases the network resources and tears down the communication link established with mobile terminal 212. In the described embodiment, the “ping” requests are LCP-Echo Requests.

The area shown generally at 216 illustrates an area in which a mobile terminal, such as mobile terminal 212, experiences interference (either electrical or topographical). If mobile terminal 212, while in area 216, experiences interference and loses RF, then mobile terminal, upon regaining RF, evaluates whether to generate communication signals to the PDSN (here, PDSN 202) to alert it of its presence to keep PDSN 202 from initiating session tear down procedures. As will be described in greater detail, the PDSN 202 produces a PPP inactivity time remaining timer value that the mobile terminal uses to initialize an internal counter. The mobile terminal then evaluates the value of the internal counter upon regaining RF to determine whether to generate a “ping” (e.g, an LCP Echo-Request or LCP Echo Reply) or to initialize session setup procedures.

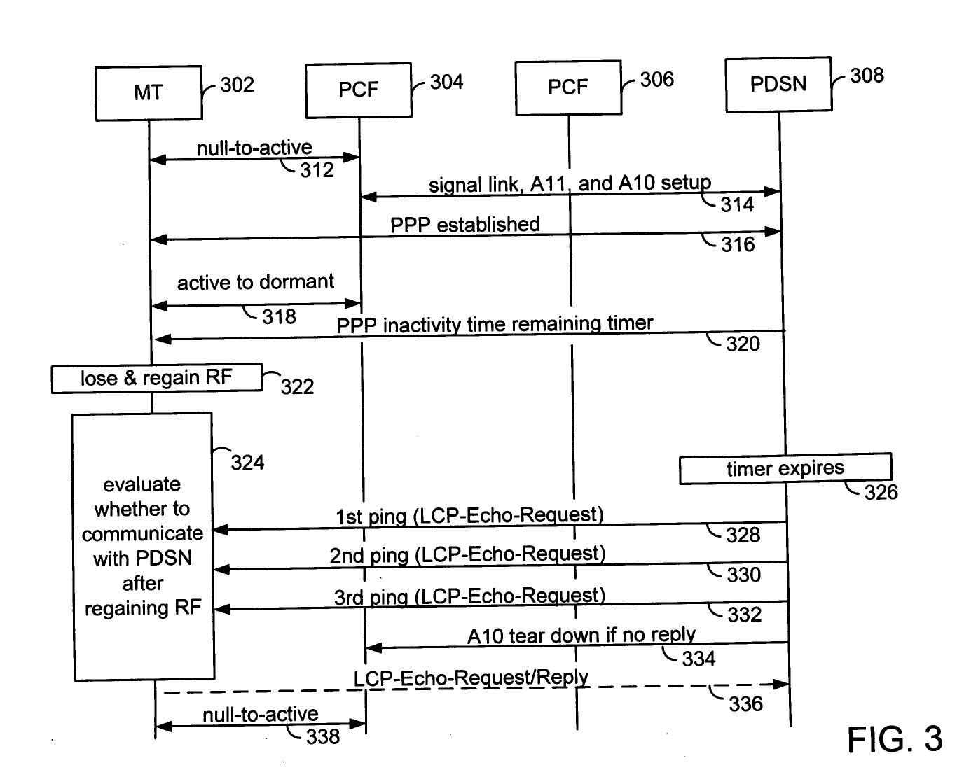

FIG. 3 is a signal sequence diagram that illustrates an embodiment of the present invention. As may be seen, a mobile terminal 302 is coupled to communicate with a PCF 304, a PCF 306, and a PDSN 308 in a wireless data packet network (e.g, a 1xRTT network, a 1xEVDO network or a 1xEVDV network). Initially, a mobile terminal establishes a communication link through PDSN 308. More specifically, mobile terminal 302 establishes a communication link with PDSN 308 by exchanging call setup signals 312 (null-to-active signals) with PCF 304 to indicate that mobile terminal 302 is transitioning to an active state. As may be seen, signal 312 is transmitted from mobile terminal 302 by way of a BTS (not shown) to PCF 304. PCF 304, thereafter, generates A11 signaling to establish the call and A10 setup signals to PDSN 308 in what is shown as signal 314. As is understood by one of average skill in the art, A11 and A10 refer to defined interfaces between a PCF and a PDSN. Once the call setup signals have been received through the A10 interface, as illustrated by signal 314, PDSN 308 and mobile terminal 302 establish a point-to-point protocol communication link as referenced by signal 316. After the creation of the point-to-point protocol communication link, mobile terminal 302 transitions to a dormant state with respect to PCF 304 (and therefore, PDSN 308) as shown at 318. Thereafter, PDSN 308 provides a PPP inactivity time remaining timer value in signal 320 to mobile terminal 302. Thereafter, mobile terminal 302 loses and subsequently regains RF as shown at 322. Thereafter, mobile terminal 302 evaluates whether to communicate with PDSN 308 as shown at 324. The evaluating of 324 is a process that may occur at any time and is triggered by losing and regaining RF as shown at 322. The evaluating step generally includes only transmitting call setup signals, or “pings”, if the mobile terminal regains RF at a certain time.

According to one embodiment of the present invention, PDSN 308 includes an internal timer that is activated after the establishment of the communication link illustrated as signal 316 for tracking inactivity time of mobile terminal 302. In the present invention, however, the PPP inactivity timer is reset each time data is transmitted from mobile terminal 302 to PDSN 308 or a signal, such as an acknowledged signal or reply signal, is received by PDSN 308 from mobile terminal 302. If the PPP inactivity timer expires without any activity in communications with mobile terminal 302 as shown at 326, PDSN 308 generates a “ping” to mobile terminal 302. In the described embodiment of the invention, the “ping” is an “LCP Echo Request” 328. In an alternate embodiment, the “ping” is an ICMP Echo Request. The LCP Echo Request and ICMP Echo Request are both defined in the standards and are known by those of average skill in the art. Mobile terminal 302, upon receiving a ping, such as LCP Echo Request 328, generates an “LCP Echo Reply” (not shown here) to inform the PDSN that it is still present and that the point-to-point protocol communication link should not be torn down. This presumes mobile terminal 302 has RF and receives LCP Echo Request 328. For our example, however, mobile terminal 302 has lost RF. In the present example, an LCP Echo Reply is not received from mobile terminal 302. Accordingly, PDSN 308 generates a second LCP Echo Request 330. If there is still no response, a third LCP Echo Request 332 is generated. If mobile terminal 302 does not reply either to signals 328, 330, or 332, PDSN 308 generates signal 334 to PCF 304 over the A10 interface to instruct it to tear down the point-to-point protocol communication link 324. Thereafter, the resources are released and, if necessary, assigned to a subsequent mobile terminal.

Whenever the mobile terminal gains RF, it must determine whether to make its presence known to PDSN 308. In the described embodiment of the invention, as previously stated, mobile terminal 302 received PPP inactivity time remaining timer value 320 from PDSN 308, which it used to initialize an internal counter to approximately track a PPP inactivity timer within PDSN 308 plus the sum of a specified number of “pings” and associated response times therefore. Accordingly, when the mobile terminal regains RF, as shown at 324, it makes the determination whether any communication signals may be sent to PDSN 308. The logic for determining whether communication signals need to be transmitted to PDSN 308 may readily be determined and modified by one of average skill in the art. In the described embodiment of the invention, mobile terminal 302 does not initiate communications with PDSN 308 unless the value of its internal timer which was initialized with the PPP inactivity time remaining timer value received from PDSN 308 has transitioned to 0 indicating that the PPP inactivity time has transitioned to 0 and a specified number of “pings” (LCP Echo Requests in the described embodiment) have been transmitted. Accordingly, the logic for mobile terminal 302 may include the mobile terminal transmitting an LCP Echo Request to PDSN 308, an LCP Echo Reply to PDSN 308 or any other communication in a signal 336 to advise PDSN 308 that it is present. Alternatively, if the PPP inactivity time remaining timer value as reflected by an internal counter within mobile terminal 302 is equal to 0, mobile terminal 302 may be formed to merely initiate the setup of a new data session. Accordingly, for this embodiment, a null-to-active set of signals 338 is exchanged between mobile terminal 302 and PCF 304 to initiate the establishment of a new PDP signal length.

More generally, the logic within the mobile terminal 302 may be set up to determine whether a first “ping” has been generated, whether a final “ping” has been generated, and whether an established PPP session has been torn down according to the logic associated with the internal timer that is based upon the PPP inactivity time remaining timer value received from PDSN 308, as well as known logic for generating “pings”. For example, if mobile terminal 302 is aware that PDSN 308 produces 3 “pings” and that a reply time is defined to last 10 seconds after each “ping”, then mobile terminal 302 may readily determine whether it is within 10 seconds of a last “ping” (third “ping”) and whether to merely produce an LCP Echo Reply or whether to initiate communication signals establish a PPP communication link or data session.

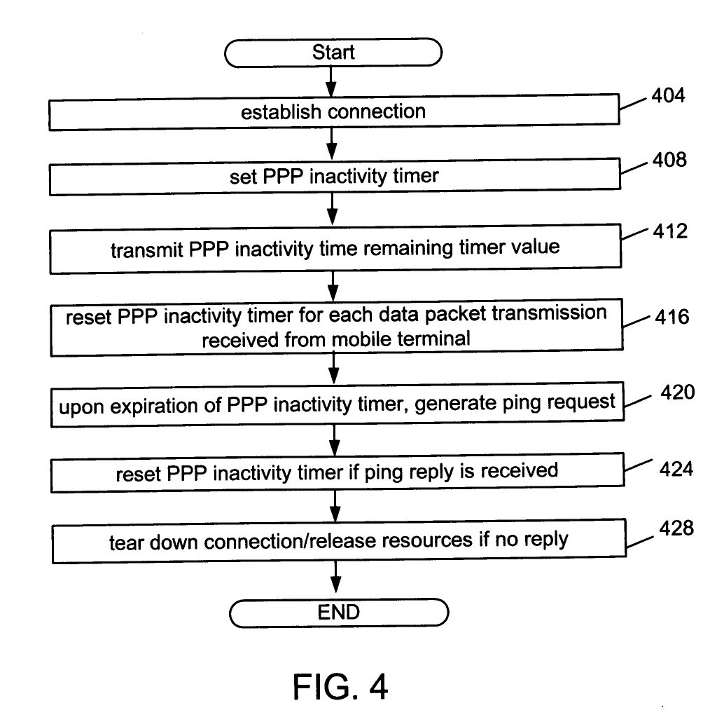

FIG. 4 is a flowchart that illustrates one method of the present invention in a PDSN. Initially, a point-to-point protocol communication link is established between a mobile terminal and the PDSN (step 404). Thereafter, a PPP inactivity timer is set by the PDSN (step 408). The PDSN then transmits a PPP inactivity time remaining timer value (step 412). In one embodiment of the invention, the PPP inactivity timer is reset upon receipt of a data packet or signal from the mobile terminal for which the connection was established in step 404 (step 416). Once the PPP inactivity timer has expired, or counted down to 0, the PDSN generates at least one “ping” request (step 420). In the described embodiment of the invention, the “ping” request is an LCP Echo Request. After the “ping” request is generated, the PPP inactivity timer is reset if the mobile terminal replied to the “ping” request and the reply is received (step 424). If a “ping” reply is not received after the at least one “ping” request is transmitted, the PDSN instructs the PCF that established the point-to-point protocol communication link to tear down the connection and release the resources (step 428).

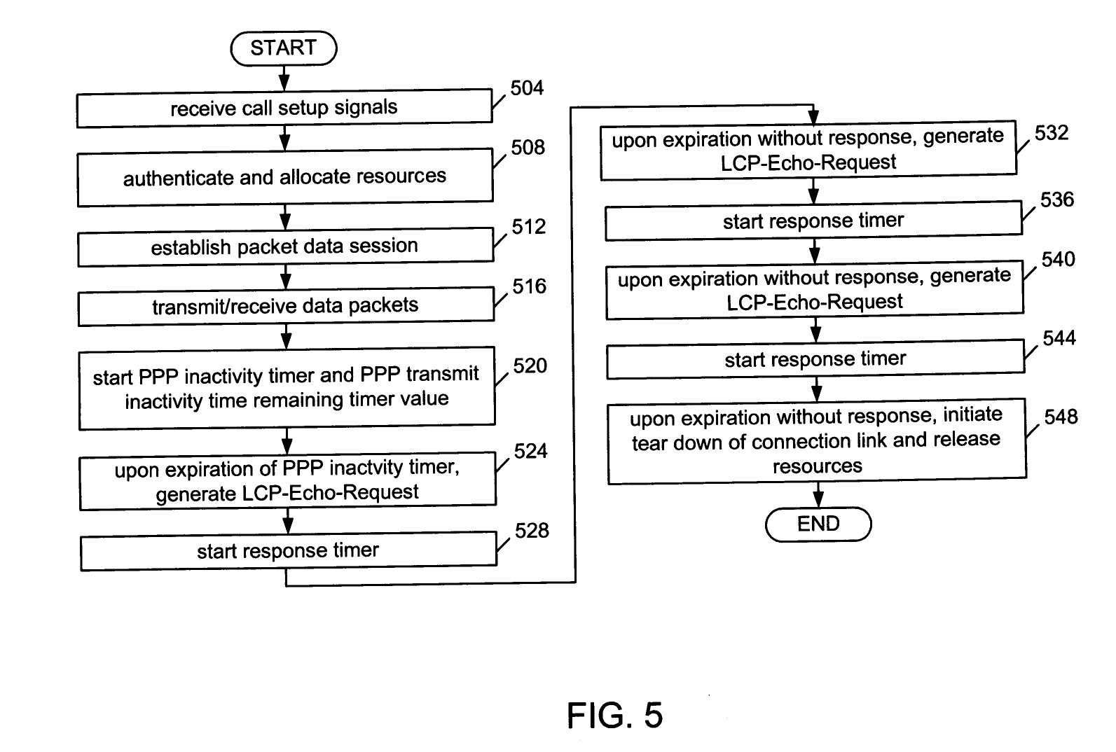

FIG. 5 is a flowchart that illustrates a second aspect of one embodiment of the present invention. In general, the method of FIG. 5, like the method of FIG. 4, is performed by a PDSN. Initially, the PDSN receives call setup signals over the A10 interface from a PCF for a mobile terminal being serviced by the PCF (step 504). Thereafter, the PDSN communicates with an AAA server to authenticate the mobile terminal ID and thereafter allocates resources thereto (step 508). Upon authenticating the mobile terminal ID and communicating with the PCF, a point-to-point protocol communication link, or data packet session, is established between the PDSN and the mobile terminal 512. As is understood, establishing the packet data session means that the PDSN further communicates through a data packet network, and more specifically, to a device to which it is coupled through the data packet network that is providing or receiving data from the mobile terminal for which the communication link was established. Thus, the PDSN transmits and receives data packets between the mobile terminal and the external device coupled to the data packet network (step 516). Once the communication link has been established and data packets are no longer being transmitted and received, the PDSN starts a PPP inactivity timer and transmits a PPP inactivity time remaining value to the mobile terminal (step 520). Upon the expiration of the PPP inactivity timer that was set in step 520, the PDSN generates an LCP Echo Request that is transmitted to the mobile terminal by way of the PCF that established the point-to-point protocol communication link (step 524). Once the LCP Echo Request has been generated, the PDSN initiates a response timer (step 528). Upon expiration of the response timer, without a response, the PDSN generates a second LCP Echo Request to the mobile terminal (step 532). As soon as the second LCP Echo Request is generated to the mobile terminal, the response timer is reset (step 536). Upon expiration of the response timer, without a response, the PDSN generates an LCP Echo Request to the mobile terminal for a third time (step 540). Thereafter, the response timer is reset again (step 544). After this, if the response timer expires without a response, the PDSN instructs the PCF to tear down the communication link and to release the resources (step 548).

As described herein, the method of FIG. 5 illustrates that the mobile terminal is getting three opportunities to reply to the LCP Echo Request with an LCP Echo Reply signal. This is done to minimize the likelihood of an inadvertent tear down of a point-to-point protocol communication link. The amount of time allocated for the response may vary, but in general is set in keeping with normal periods for such responses as is known by those of average skill in the art. With respect to the PPP inactivity timer, however, that value may be set in many different durations. In the described embodiment of the invention, the inactivity timer is set to a period of hours. One reason that the value is relatively high and is in the range of hours is that a point-to-point protocol communication link that is established for a mobile terminal consumes little resources while the mobile terminal is in a dormant mode or state. Given that each generation of an LCP Echo Request consumes notable network resources, it is undesirable to establish a system that generates a significant number of LCP Echo Requests. In such a case, the cure may be worse than the ailment. According to one embodiment of the present invention, the inactivity timer is therefore set to a period of hours.

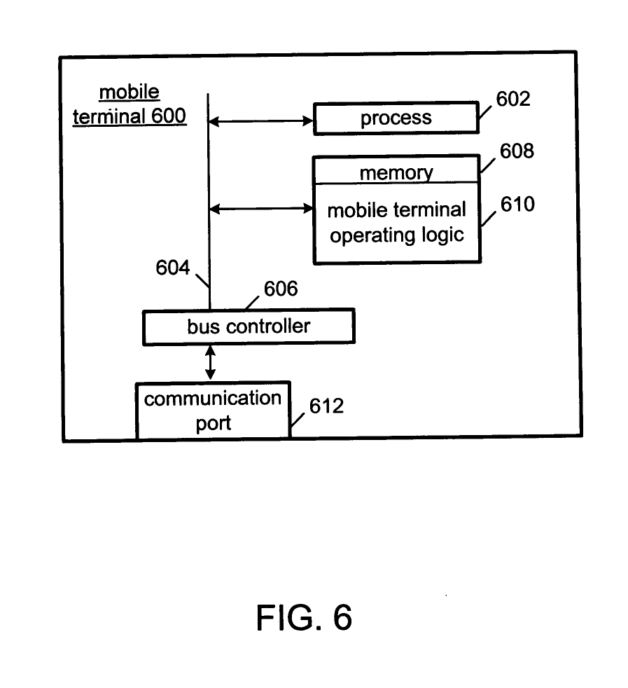

FIG. 6 is a functional block diagram that illustrates one embodiment of a mobile terminal. Referring now to FIG. 6, a mobile terminal 600 includes a processor 602 that is coupled to communicate over a bus 604. A bus controller 606 controls communications over bus 604. A memory 608 further is coupled to bus 604 and includes computer instructions that are retrieved by processor 602 over bus 604 for execution. The computer instructions within memory 608 define the operational logic of mobile terminal 600. For example, memory 608 includes a memory portion 610 that includes computer instructions that define the mobile terminal operational logic. Specifically, the computer instructions within memory portion 610 define logic for generating LCP Echo Requests upon the expiration of an internal timer based upon a received LCP Echo Reply and PPP session setup signals timer. More specifically, the computer instructions within memory portion 610 define logic that is described by the signal sequence diagram and flowcharts and other descriptions herein of the present embodiment of the invention. Bus controller 606 further is coupled to a communication port 612 through which mobile terminal 600 communicates with external devices. Thus, when processor 602 retrieves the computer instructions stored within memory portion 610 and executes them to determine that it should generate an LCP Echo Request, processor 602 formats the signal and transmits it over bus 604 through bus controller 606 and out a communication port 612 for transmission to the mobile terminal through the corresponding PCF.

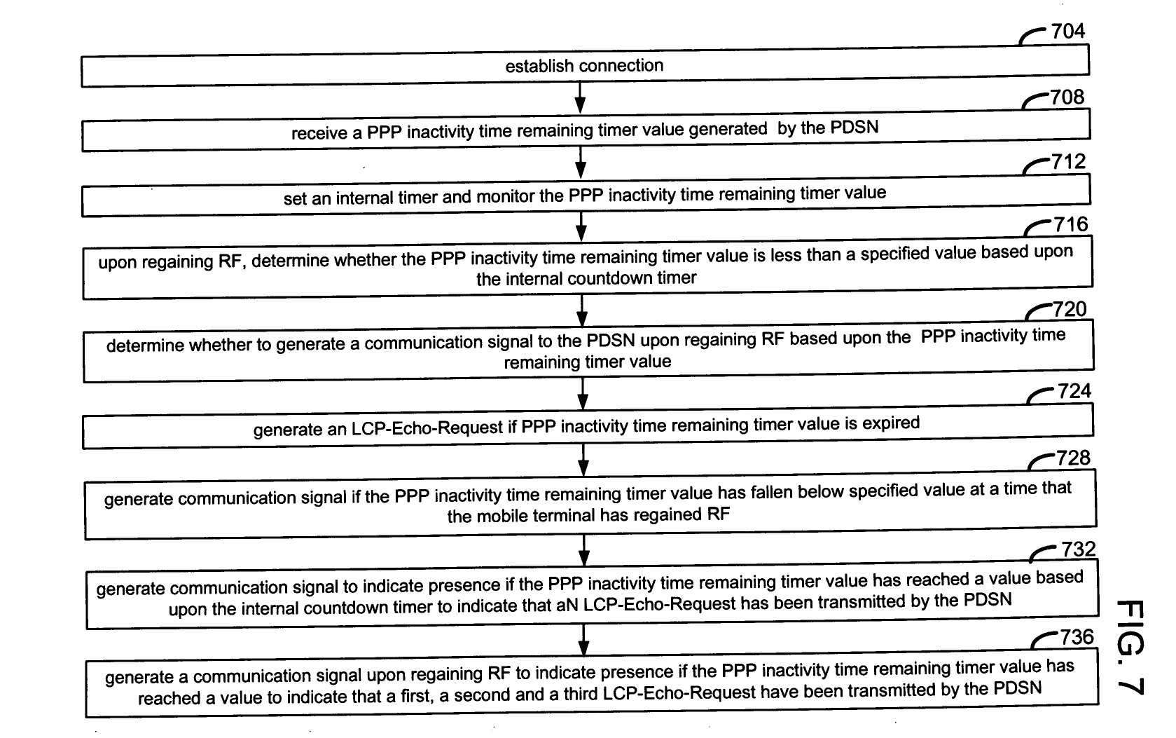

FIG. 7 is a flow chart illustrating a method of a mobile terminal according to one embodiment of the present invention. Initially, a mobile terminal in a PPP network comprising front end transceiver circuitry for communicating with a packet data serving node (PDSN) over a PPP network establishes a connection (step 704) and receives a PDSN PPP inactivity time remaining timer value generated and transmitted by the PDSN to the mobile terminal (step 708). Thereafter, the mobile terminal sets an internal countdown timer and internally monitors the PDSN PPP inactivity time remaining timer value (step 712). Whenever the mobile terminal loses RF (fails to receive a pilot signal), the mobile terminal determines whether the PDSN PPP inactivity time remaining timer value is less than a specified value based upon the internal countdown timer (step 716) and further determines whether to generate a communication signal to the PDSN upon regaining RF based upon the PDSN PPP inactivity time remaining timer value as reflected in the internal countdown timer based upon the internal countdown timer (step 720).

Based upon the above-described determinations, the mobile terminal generates an LCP-Echo-Request if the PDSN PPP inactivity time remaining timer value has expired (decremented to zero) while the mobile terminal was not receiving communication signals from a base station (step 724). Alternatively, the mobile terminal generates a communication signal to indicate its presence if the PDSN PPP inactivity time remaining timer value has fallen below the specified value at a time that the mobile terminal has regained RF based upon the internal countdown timer (step 728). As yet another aspect of the present invention, the mobile terminal generates a communication signal upon regaining RF to indicate its presence if the PDSN PPP inactivity time remaining timer value has reached a value based upon the internal countdown timer to indicate that a first LCP Echo Request has been transmitted by the PDSN (step 732). Finally, as yet another aspect or embodiment of the present invention, the mobile terminal generates a communication signal upon regaining RF to indicate its presence if the PDSN PPP inactivity time remaining timer value has reached a value to indicate that a first, a second and a third LCP Echo Request have been transmitted by the PDSN (step 736).

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A packet data serving node (PDSN) within a PPP network, comprising:
a bus coupled to a processor for transmitting computer instructions and control signals to and from the processor within the PDSN;
memory coupled to the bus, the memory including computer instructions that define operational logic for causing the PDSN to operate a PPP inactivity timer and to generate at least one Link Control Protocol (LCP) Echo Request signal to a mobile terminal upon expiration of the PPP inactivity timer;
the processor for executing computer instructions wherein the processor retrieves the computer instructions from the memory over the bus and executes the computer instructions to generate a first LCP Echo Request; and
wherein the PDSN further generates and produces a PPP inactivity time remaining timer value for transmission to the mobile terminal wherein the PPP inactivity time remaining timer is value is less than or equal to a sum of the PPP inactivity timer value plus an Echo Reply-Timeout timer value times the sum of Echo Request Retries+1 and wherein the value of the PPP inactivity time remaining timer value is greater than the PPP inactivity timer and further wherein the Echo Request Retries is greater than or equal to zero.

2. The PDSN of claim 1 wherein the computer instructions stored within the memory define logic to prompt the processor to set a Echo Reply-Timeout timer each time the LCP Echo Request is transmitted and to adjust an Echo Request Retries counter value and to generate a second LCP Echo Request upon expiration of the Echo Reply-Timeout timer as long as a total number of LCP Echo Requests transmitted since the PPP inactivity timer was last reset is less than or equal to a specified number as determined by evaluating the Echo Request Retries counter value.

3. The PDSN of claim 2 wherein the computer instructions stored within the memory define logic to prompt the processor to set the Echo Reply-Timeout timer and to adjust the Echo Request Retries counter and to generate a third LCP Echo Request upon expiration of the Echo-Reply-Timeout timer as long as the total number of LCP Echo-Requests transmitted since the PPP inactivity timer was last reset is less than or equal to as long as a total number of LCP Echo-Requests transmitted since the PPP inactivity timer was last reset is less than or equal to the specified number as determined by evaluating the Echo Request Retries counter value.

4. The PDSN of claim 1 wherein the computer instructions define logic to prompt the processor to reset the PPP inactivity timer every time a communication signal is received from the mobile terminal including one of an LCP Echo Request and an LCP Echo Reply.

5. The PDSN of claim 1 wherein the PDSN, upon expiration of the PPP inactivity timer, generates the LCP Echo Request and initializes the Echo Reply-Timeout timer. Upon expiration of the Echo-Reply-Timeout timer, the PDSN sends a subsequent LCP Echo Request if the Echo Request Retries counter value is greater than zero and subsequently decrements the Echo Request Retries counter value by one and reinitializes the Echo Reply-Timeout timer.

6. The PDSN of claim 5 wherein the processor generates a third LCP Echo Request if a reply is not received for the second LCP Echo Request that was generated.

7. The PDSN of claim 5 wherein, if the Echo Reply-Timeout timer and the Echo Request Retries counter value are both equal to zero, the PDSN closes the PPP data session.

8. PPP communication network circuitry including a wireless communication network portion for establishing “always on” type communication links for transmitting data, the network circuitry comprising:
radio transceiver circuitry for establishing a radio frequency (RF) communication link with a mobile terminal;
an Access Network Controller/Base Station Controller (ANC/BSC) for establishing and controlling the RF communication link, the ANC/BSC coupled to communicate with the radio transceiver circuitry and to transmit and receive communication signals thereto and therefrom, respectively,
a packet control function (PCF) network element coupled to the ANC/BSC, the PCF for converting data between an IP protocol and a wireless network protocol; and
a packet data serving node (PDSN) coupled to the PCF, the PDSN for establishing a connection between a packet data network and the PCF, the PDSN including logic to generate a PPP inactivity timer within the PDSN and to generate an LCP Echo Request upon expiration of the PPP inactivity timer, the PDSN further including logic to transmit a PPP inactivity time remaining timer value to the mobile terminal by way of the radio transceiver circuitry.

9. The PPP communication network circuitry of claim 8 wherein the PDSN further includes logic to tear down a communication link if the PDSN does not receive an LCP Echo Reply from the mobile terminal within a specified period after generation of the LCP Echo Request.

10. The PPP communication network circuitry of claim 9 wherein the PDSN does not tear down the communication link unless the LCP Echo Reply was not received after the LCP Echo Request was generated a plurality of times.

11. The PPP communication network circuitry of claim 10 wherein the plurality of times comprises at least three times.

12. The PPP communication network circuitry of claim 8 wherein the PPP inactivity time remaining timer value is set to a value that is equal to or exceeds one hour.

13. The PPP communication network circuitry of claim 8 wherein the PPP inactivity time remaining timer value is set to a value that is approximately equal to three hours.

14. The PPP communication network circuitry of claim 8 wherein the PPP inactivity time remaining timer value is reset upon receipt of a communication signal from the mobile terminal including one of LCP Echo Request or LCP Echo Reply.

15. A mobile terminal in a PPP network, comprising:
front end transceiver circuitry for communicating with a packet data serving node (PDSN) wherein the mobile terminal receives a PPP inactivity time remaining timer value generated and transmitted by the PDSN to the mobile terminal;
wherein the mobile terminal sets an internal countdown timer for internally monitoring the PPP inactivity time remaining timer value, wherein, whenever the mobile terminal loses RF (fails to receive a control channel signal), the mobile terminal determines whether the PPP inactivity time remaining timer value is less than a specified value based upon the internal countdown timer and further determines whether to generate a communication signal to the PDSN upon regaining RF based upon the PPP inactivity time remaining timer value as reflected in the internal countdown timer based upon the internal countdown timer.

16. The mobile terminal of claim 15 wherein the mobile terminal generates an LCP Echo Request if the PPP inactivity time remaining timer value has expired (decremented to zero) while the mobile terminal was not receiving communication signals from a base station.

17. The mobile terminal of claim 15 wherein the mobile terminal generates the communication signal to indicate presence if the PPP inactivity time remaining timer value has fallen below the specified value at a time that the mobile terminal has regained RF based upon the internal countdown timer.

18. The mobile terminal of claim 15 wherein the mobile terminal generates the communication signal upon regaining RF to indicate presence if the PPP inactivity time remaining timer value has reached a value based upon the internal countdown timer to indicate that a first LCP Echo Request has been transmitted by the PDSN.

19. The mobile terminal of claim 18 wherein the communication signal to indicate presence is one of LCP Echo Request, LCP Echo Reply, or solicitation signal to establish a PPP connection if the mobile terminal determines that the PDSN has (should have) torn down the PPP connection for lack of receipt of the LCP Echo Reply.

20. The mobile terminal of claim 15 wherein the mobile terminal generates the communication signal upon regaining RF to indicate presence if the PPP inactivity time remaining timer value has reached a value to indicate that a first, a second and a third LCP Echo Request have been transmitted by the PDSN.
